(19) United States
(12) Patent Application Publication
(10) Pub. No.: US 2025/0285138 A1
(43) Pub. Date: Sep. 11, 2025

(54) COMPUTER IMPLEMENTED SYSTEM AND METHOD FOR PROTECTING INDIVIDUALS FROM FALSE ADVERTISING AND DECEPTIVE CONDUCT IN AN ONLINE ENVIRONMENT

(71) Applicant: Adnana IONESCU, Beverley, South Australia (AU)

(72) Inventor: Adnana IONESCU, Beverley, South Australia (AU)

(21) Appl. No.: 18/862,565

(22) PCT Filed: Apr. 20, 2023
(86) PCT No.: PCT/AU2023/050324

§ 371 Date: Nov. 4, 2024

(30) Foreign Application Priority Data
May 5, 2022 (AU) 2022901186

(51) Int. Cl. G06Q 30/0241; G06Q 30/018; G06Q 30/0207

(52) U.S. Cl. CPC G06Q 30/0248; G06Q 30/0185; G06Q 30/0225; G06Q 30/0277

(57) ABSTRACT

The present disclosure relates to a system and method for providing protection to online users with respect to third parties who issue false advertisements in respect of goods and/or services and who seek to obtain payment from users with no intention of providing the advertised goods. The present disclosure finds particular application in protecting users of social media, and assists to protect online users from any type of deceptive conduct across social media channels such that users may utilize the services of social media whilst having confidence that they are substantially protected from the false advertising of third parties.

### CROSS-REFERENCE TO RELATED APPLICATIONS

This application is a 371 U.S. National Phase of PCT International Patent Application No. PCT/AU2023/050324 filed on Apr. 20, 2023, which claims priority from Australian Provisional Patent Application No. 2022901186 dated May 5, 2022, the disclosures of which are incorporated by reference herein in their entirety for all purposes.

### FIELD OF THE INVENTION

The present disclosure relates to a system and method for providing protection to online users with respect to third parties who issue false advertisements in respect of goods and/or services and who seek to obtain payment from users with no intention of providing the advertised goods and/or services. The present disclosure finds particular application in protecting users of social media, and assists to protect online users from any type of deceptive conduct across social media channels such that users may utilize the services of social media whilst having confidence that they are substantially protected from the false advertising of third parties.

### BACKGROUND OF THE INVENTION

Due to advances associated with the internet, wireless communication, computers and smart devices that enable the creation of online social environments and communication platforms, the social landscape has experienced rapid changes in recent years, particularly in the way individuals shop for goods and services.

The observed increase in popularity associated with online social environments is primarily attributable to the convenience associated with the use of computers and/or smartphones, since such devices enable users to order and purchase items advertised for sale at any time of the day whilst remaining within their own environment. For example, there are a number of high profile online shopping platforms including eBay, Amazon and Alibaba which have become so well known, that online consumers feel confident that they are substantially protected if they order and pay (by electronic funds transaction) for items advertised for sale on such platforms.

However, goods are also advertised on lower profile websites and platforms and also as pop-up advertising, and there have been numerous instances of online fraud where consumers have ordered and paid for items offered for sale by deceptive parties who have no intention of providing the advertised goods once ordered and paid for by the consumer. Such interactions are colloquially referred to as “scams”, and involve “scammers” pretending to be legitimate online vendors by advertising goods on a fake website.

Although most online vendors are legitimate, unfortunately “scammers” can use the anonymous nature of the internet to deceive inexperienced online consumers, by either creating a fake advertisement on a genuine retailer website, or more often, by creating a fake website. In this regard, scammers may use sophisticated technology to establish fake websites that adopt designs, layouts, misappropriated logos and domain names to imitate the website or a genuine online retailer and thereby essentially pass themselves off as a genuine online retailer. Many of these fake websites offer luxury items such as popular brands of clothing, jewelry and electronics at significantly lower prices as compared with the consumer's expectation. However, the items are either poor quality imitations or, are not available for purchase. In 2020, it was estimated that the global cost to consumers resulting from false advertising amounted to approximately USD 25 billion and is increasing each year.

A more recent version of online shopping scams involves the use of social media platforms to establish fake online stores on which to advertise fake websites which typically appear and disappear in a short period of time, usually after a particular number of sales are made. Under such circumstances, there is little or no chance that a consumer will be able to recover their funds after engaging in a transaction.

Accordingly, there exists a need for a system and method that is operable to provide a safe and secure means for consumers to search for, and purchase, items advertised for sale on websites and other online environments whilst having the confidence that they are substantially protected from the deceptive conduct of third parties.

The reference to any prior art in this specification is not, and should not be taken as, an acknowledgement or any suggestion, that the prior art forms part of the common general knowledge.

### SUMMARY OF THE INVENTION

In one aspect, the present disclosure provides a computer-implemented method for reducing individuals from exposure to false and/or deceptive online advertising, the method including, receiving, by one or more processors, social media streams from social media sites for one or more social media user accounts associated with a user and filtering the social media stream(s) to identify content regarding advertisements for goods and/or services, processing, by one or more processors, the content by subjecting each advertisement identified in the stream(s) to an assessment process to identify any false and/or deceptive content, wherein the assessment process includes, determining whether the advertisement has been published anywhere in the world by an entity other than the advertising entity associated with the advertisement under assessment, determining whether the goods and/or services have been advertised anywhere in the world for a price other than as advertised in the advertisement under assessment, and determining a likelihood that the advertisement under assessment includes false and/or deceptive content according to either one or both of, the presence of one or more publications of the advertisement for the goods and/or services by an entity other than the advertising entity associated with the advertisement under assessment, and the presence of one or more publications of the advertisement for the goods and/or services at a price other than as advertised in the advertisement under assessment, and based on a determination that the advertisement includes false and/or deceptive content above a pre-determined threshold, withholding, by one more processors, provision of the advertisement to the user, or providing, by one or more processors, the advertisement to the user with a warning that the advertisement is likely to be false and/or deceptive.

In a non-limiting embodiment, determining the presence of one or more publications of the advertisement for the goods and/or services by any entity other than the advertising entity associated with the advertisement under assessment, or determining the presence of one or more publications of the advertisement for goods and/or services at a price other than as advertised in the advertisement under assessment, includes automatically conducting a search for other online advertisements that pertain to goods and/or services identical to those advertised in the advertisement.

In a non-limiting embodiment, searching for other online advertisements that pertain to goods and/or services identical to those advertised in the advertisement includes one or more of, searching using an online search engine, or searching a database or repository of active online advertisements.

In a non-limiting embodiment, the warning provided to the user when an advertisement is likely to be false and/or deceptive, includes one or more of, information pertaining to the false and/or deceptive content, a graphical display alerting the user to the false and/or deceptive advertisement, a percentage indication of likelihood that the advertisement includes false and/or deceptive content, and an indication regarding a category of likelihood that the advertisement includes false and/or deceptive content is applicable, the category being one of a plurality of different likelihood categories.

In a non-limiting embodiment, the plurality of different categories of likelihood that the advertisement includes false and/or deceptive content include “likely”, “unlikely”, and “extremely likely”.

In a non-limiting embodiment, the method further includes determining, by one or more processors, particular entities as legitimate advertisers of goods and/or services based upon a threshold number of advertisements issued by the entities determined not to include false and/or deceptive content, and automatically allowing advertisements from entities determined legitimate advertisers of goods and/or services to be provided to users.

In a non-limiting embodiment, the method further includes determining, by one or more processors, particular entities as illegitimate advertisers of goods and/or services based upon a threshold number of advertisements issued by the entities determined to include false and/or deceptive content, storing, in a repository, details relating to the entities determined illegitimate advertisers of goods and/or services, and automatically withholding advertisements from the entities determined illegitimate advertisers of goods and/or services.

In a non-limiting embodiment, the method further includes training, by one or more processors, a machine learning model with respect to the characteristics of entities determined illegitimate advertisers of goods and/or services, and utilizing, by one or more processors, the trained machine learning model to assess new entities regarding their legitimacy including whether the advertisements provided by the entities include false and/or deceptive content according to pre-determined threshold.

In a non-limiting embodiment, the characteristics of entities used to train the machine learning model are determined based upon one or more of, accessing a database storing who have provided false and/or deceptive advertisements, and feedback from entities who have been erroneously determined as illegitimate advertisers of goods and/or services.

In a non-limiting embodiment, when one or more publications of the advertisement for the goods and/or services by a particular entity other than the advertising entity associated with the advertisement under assessment is located, the method further includes, determining, by one or more processors, whether the particular entity is recorded in the repository of entities determined illegitimate advertisers of goods and/or services, and based upon the entity not being recorded in the repository and hence likely to be a legitimate advertiser of goods and/or services, determining, by one or more processors, that the advertisement includes false and/or deceptive conduct according to the pre-determined threshold.

In a non-limiting embodiment, when one or more publications of the advertisement for the goods and/or services at a particular price other than as advertised in the advertisement under assessment is located, the method further includes, determining, by one or more processors, the extent to which the particular price differs from the price advertised in the advertisement, and based upon the particular price exceeding the price advertised in the advertisement by more than a predefined percentage of the advertised price, determining, by one or more processors, that the advertisement includes false and/or deceptive conduct according to the pre-determined threshold.

In a non-limiting embodiment, only those advertisements associated with a particular category or categories selected as of interest to the user are provided to the user to the exclusion of advertisements associated with other categories.

In a non-limiting embodiment, the method further includes determining, by one or more processors, the advertising entity associated with the advertisement under assessment, and verifying, by one or more processors using one or more verification techniques, the advertising entity as legitimate advertisers of goods and/or services.

In a non-limiting embodiment, the method further includes prompting, by one or more processors, the user to specify a geographical location associated with the user, or automatically tracking, by one or more processors, a geographical location of the user using global positioning system functionality implemented by a user's device.

In a non-limiting embodiment, the method further includes storing, by one or more processors, details relating to advertisements considered to contain false and/or deceptive content and associating same with the geographical location of users who have received the advertisement, and determining, by one or more processors, a geographical region targeted by an advertising entity responsible for issuing the advertisement.

In a non-limiting embodiment, the method further includes, based upon detection of a user in a particular geographic location receiving an advertisement that contains false and/or deceptive content, automatically withholding further advertisements from the advertising entity responsible for issuing the advertisement, and alerting other users within a predefined vicinity of the geographic location of the user to be aware that such advertisements have been received by another user within the same geographical region.

In a non-limiting embodiment, the method further includes providing, by one or more processors, a chat facility enabling users to communicate with one another including in relation to false and/or deceptive advertisements encountered by users.

In another aspect, the present disclosure provides a computer-implemented system for reducing individuals from exposure to false and/or deceptive online advertising, the system including, one or more processors configured to, receive social media streams from social media sites for one or more social media user accounts associated with a user and filtering the social media stream(s) to identify content regarding advertisements for goods and/or services, process the content by subjecting each advertisement identified in the stream(s) to an assessment process to identify any false and/or deceptive content, wherein the assessment process includes, determining whether the advertisement has been published anywhere in the world by an entity other than the advertising entity associated with the advertisement under assessment, determining whether the goods and/or services have been advertised anywhere in the world for a price other than as advertised in the advertisement under assessment, and determining a likelihood that the advertisement under assessment includes false and/or deceptive content according to either one or both of, the presence of one or more publications of the advertisement for the goods and/or services by an entity other than the advertising entity associated with the advertisement under assessment, and the presence of one or more publications of the advertisement for the goods and/or services at a price other than as advertised in the advertisement under assessment, and based on a determination that the advertisement includes false and/or deceptive content above a pre-determined threshold, withhold provision of the advertisement to the user, or provide the advertisement to the user with a warning that the advertisement is likely to be false and/or deceptive.

In a still further aspect, the present disclosure provides a computer-readable medium including computer instruction code that, when executed on a computer, causes one or more processors of the computer to perform the steps of, receive social media streams from social media sites for one or more social media user accounts associated with a user and filtering the social media stream(s) to identify content regarding advertisements for goods and/or services, process the content by subjecting each advertisement identified in the stream(s) to an assessment process to identify any false and/or deceptive content, wherein the assessment process includes, determining whether the advertisement has been published anywhere in the world by an entity other than the advertising entity associated with the advertisement under assessment, determining whether the goods and/or services have been advertised anywhere in the world for a price other than as advertised in the advertisement under assessment, and determining a likelihood that the advertisement under assessment includes false and/or deceptive content according to either one or both of, the presence of one or more publications of the advertisement for the goods and/or services by an entity other than the advertising entity associated with the advertisement under assessment, and the presence of one or more publications of the advertisement for the goods and/or services at a price other than as advertised in the advertisement under assessment, and based on a determination that the advertisement includes false and/or deceptive content above a pre-determined threshold, withhold provision of the advertisement to the user, or provide the advertisement to the user with a warning that the advertisement is likely to be false and/or deceptive.

In a yet further aspect, the present disclosure provides a portable electronic device for use by a user seeking to engage in online activity whilst further seeking to reduce exposure to false and/or deceptive online advertising, the device including, a touch screen configured to receive an input corresponding to a touch operation of the user on an area of the touch screen, and a processor connected to the touch screen, wherein the processor is configured to detect the input to the touch screen and perform operations including, detecting, via the touch screen, a first input from a user requesting access to social media streams of social media sites for one or more social media accounts associated with the user, identifying content regarding advertisements for goods and/or services in the social media streams, processing the content by subjecting each advertisement identified in the stream(s) to an assessment process to identify false and/or deceptive content, wherein the assessment process includes, determining whether the advertisement has been published anywhere in the world by an entity other than the advertising entity associated with the advertisement under assessment, determining whether the goods and/or services have been advertised anywhere in the world for a price other than as advertised in the advertisement under assessment, and determining a likelihood that the advertisement under assessment includes false and/or deceptive content according to either one or both of, the presence of one or more publications of the advertisement for the goods and/or services by an entity other than the advertising entity associated with the advertisement under assessment, and the presence of one or more publications of the advertisement for the goods and/or services at a price other than as advertised in the advertisement under assessment, and based upon a determination that the advertisement includes false and/or deceptive content above a pre-determined threshold, withholding display of the advertisement on the touch screen, or providing the advertisement for display on the touch screen with a warning that the advertisement is likely to be false and/or deceptive.

### BRIEF DESCRIPTION OF THE DRAWINGS

Embodiments of the present disclosure will now be described in further detail with reference to the accompanying Figures in which:

FIG. 1 provides an overview of a system according to a non-limiting embodiment of the present disclosure showing, in particular, the interaction between various system components;

FIG. 2 illustrates a diagram associated with an exemplary server component within the system illustrated in FIG. 1;

FIG. 3 illustrates an exemplary flow diagram of a process that enables a user to download and install a software application, and subsequently access, or register to use, the software application, for interaction with the system illustrated in FIG. 1, including a verification interface associated with the software application;

FIG. 4 illustrates a diagram associated with additional example interfaces of the software application including an interface for enabling users to select preferred categories of advertisement, and a further interface for enabling access to social media and other sites with the software application operable to identify false or deceptive advertisements;

FIG. 5 illustrates a diagram showing additional users conducting similar online activities using laptop computers; and

FIG. 6 illustrates a diagram associated with further example interfaces of the software application including an interface for entering and viewing location data, and a chat interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

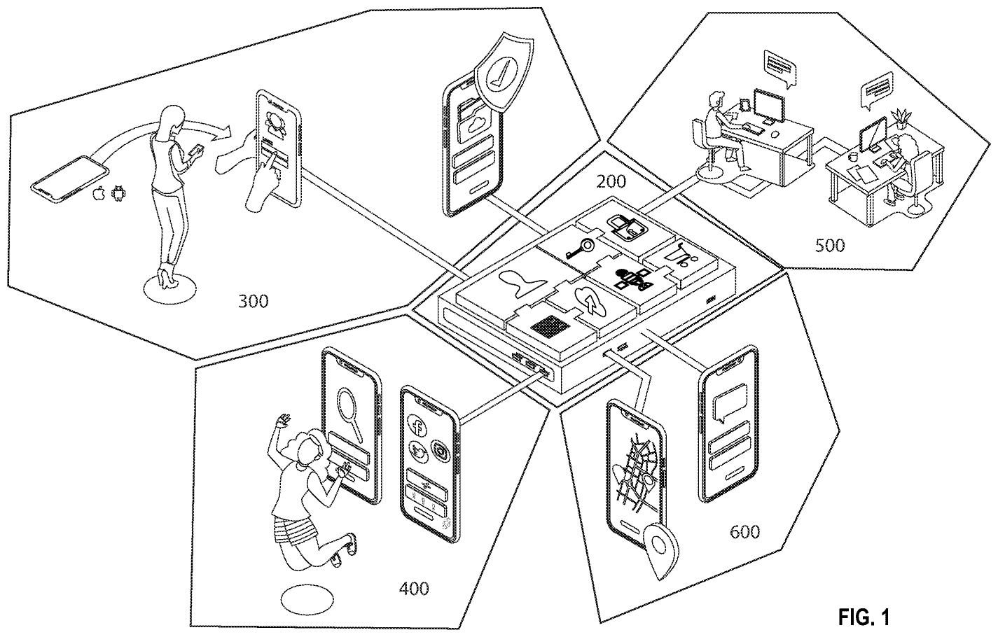

According to a non-limiting embodiment, the present disclosure provides a system and method for reducing individuals (30) from exposure to deceptive and/or false online advertising, as depicted in FIG. 1. The system and method described in the non-limiting embodiments provide a platform that hosts a computer-executable software application (40) wherein the application (40) is accessible by a plurality of users (30). The platform enables the withholding of the provision of advertisements (70) to users (30) engaging in online activity in the event the advertisements (70) are determined to include false and/or deceptive content (80) according to a pre-determined threshold. In another non-limiting embodiment, the advertisements (70) are not withheld but are appropriately marked (90) to indicate that there is a likelihood of false and/or deceptive content (80).

The platform is provided by a central server (20) which contains one or more processors and/or databases for performing functions, including receiving social media streams from social media sites in respect of one or more social media user accounts associated with each user (30), and filtering the social media streams (95) to identify content regarding advertisements (70). The server (20) is further configured to process the content using data processing functionality (125) which subjects each identified advertisement (70) to an assessment process to identify false and/or any deceptive content (80). In particular, the assessment process includes determining whether the advertisement (70) has been published anywhere in the world by an entity other than the advertising entity associated with the advertisement (70) under assessment, and determining whether the subject of the advertisement (70) (e.g. the goods and/or services advertised) have been advertised anywhere in the world for a price other than as advertised in the advertisement (70) under assessment.

In this way, if a publication of the advertisement (70) for goods and/or services by another entity is detected, this may demonstrate that the advertising entity associated with the advertisement under assessment is not authorized to advertise the particular goods and/or services, which may indicate that the advertisement (70) is false and/or deceptive. Similarly, where another publication of an advertisement is detailed for goods and/or services at a price other than as advertised in the advertisement (70) under assessment (e.g. a price that is significantly higher), this may also indicate that the particular advertisement under assessment is advertising goods and/or services at an unusually reduced price which is therefore likely to indicate false and/or deceptive content (80). Based upon the advertisement (70) assessed as including false and/or deceptive content (80) according to a pre-determined threshold, the advertisement (70) may be withheld or displayed with an appropriate warning to the user (30) when engaging in online activity (e.g. when navigating their social media streams).

The person skilled in the relevant field of technology will appreciate that the platform provides a solution to existing problems associated with the display of false and/or deceptive advertisements to users during online activity. Users (30) experience reduced exposure by restricting presentation solely to legitimate advertisements, or by providing users (30) with an accompanying warning (90) regarding likely false and/or deceptive advertisements.

In view of the above practical and useful results that arise from implementation of the present disclosure, the use of a data communications device (50) upon which the software application (40) is operated, in combination with the storage and/or processing capability of the server (20), represents an improved use of computer technology as compared with technology presently utilized for similar purposes.

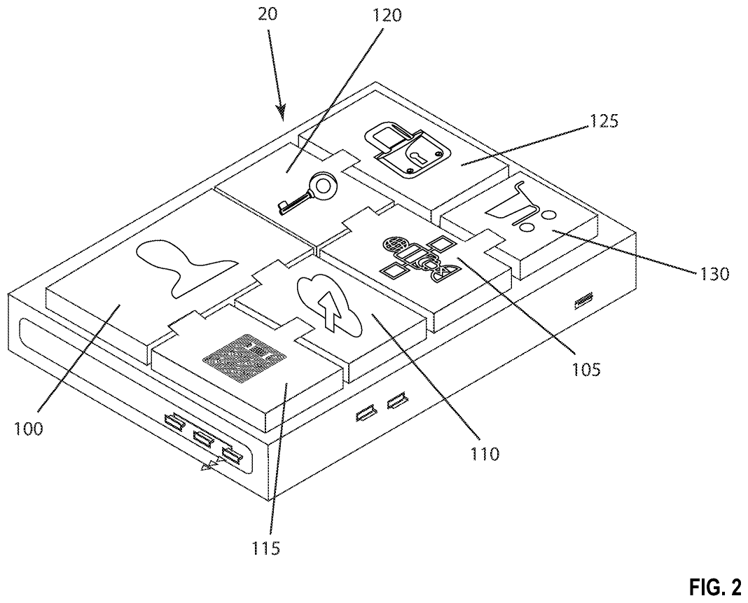

FIG. 1 is divided into segments which are further expanded in subsequent FIGS. 2-6. In particular segment (200) of FIG. 1 shows the server component (20) in respect of which a software application (40) operating on data communication devices (50) of individual users (30) is configured to communicate. It will be apparent to the person skilled in the relevant field of technology that the software application (40) may be a mobile application or a web application, and similarly, the device (50) utilized by each user (30) may be a portable device (50A) such as a mobile phone, tablet or laptop, or alternatively a fixed location device (50B) such as a personal computer. The server component (20) is additionally detailed in FIG. 2.

The skilled person will appreciate that the steps described herein may be executed by the device (50) wherein such operations are facilitated by the software application (40) operating on each device. According to another implementation of the present disclosure, the server (20) is programmed to provide most, or all, of the functions described herein particularly where they cannot be provided locally on the user devices (50) or where it may be commercially or technically impractical to implement such a configuration. In other words, the steps described herein as performed by the device (50), or components thereof, may be associated with hardware that is located externally of the device, such as the remote central server (20) for example (i.e. in a distributed architecture). Different arrangements are possible in this regard, and alternate variations will be apparent to the person skilled in the relevant field of technology.

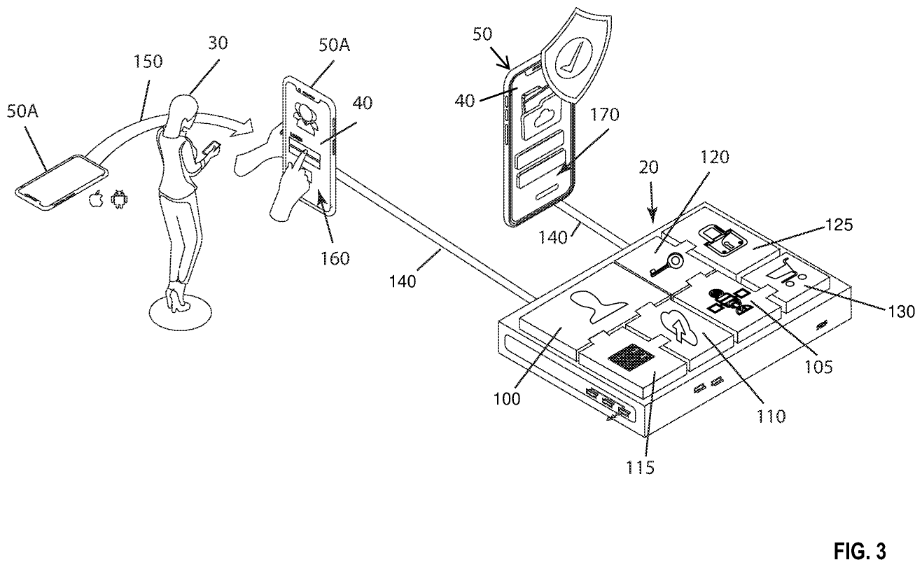

Segment 300 of FIG. 1 details how the server (20) may be configured for communication with the devices (50) associated with each user (30). In one example, the server (20) may receive data from the devices (50) for the purpose of creating a user profile (e.g. based upon the entry of details from each user (30) into interface (160)). Segment 300 of FIG. 1 further shows a user (30) downloading and installing the application (40) and subsequently accessing the application (40) to enter their identification details, as well as additional details relating to their social media user accounts and any additional accounts associated with the user's online activity (e.g. online shopping activity). Once such data has been received by the server (20), various processing steps may occur (as described in greater detail below) to identify content regarding advertisements (70) in the received social media streams (95) associated with the user (30) and to identify any false and/or deceptive content (80). Segment 300 includes a further interface (170) for verifying the identified advertising entities, as further detailed in FIG. 3.

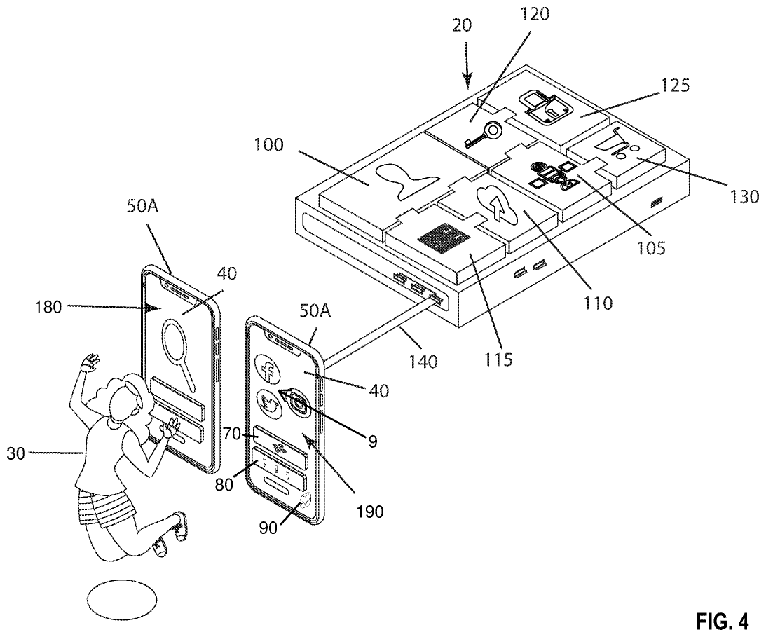

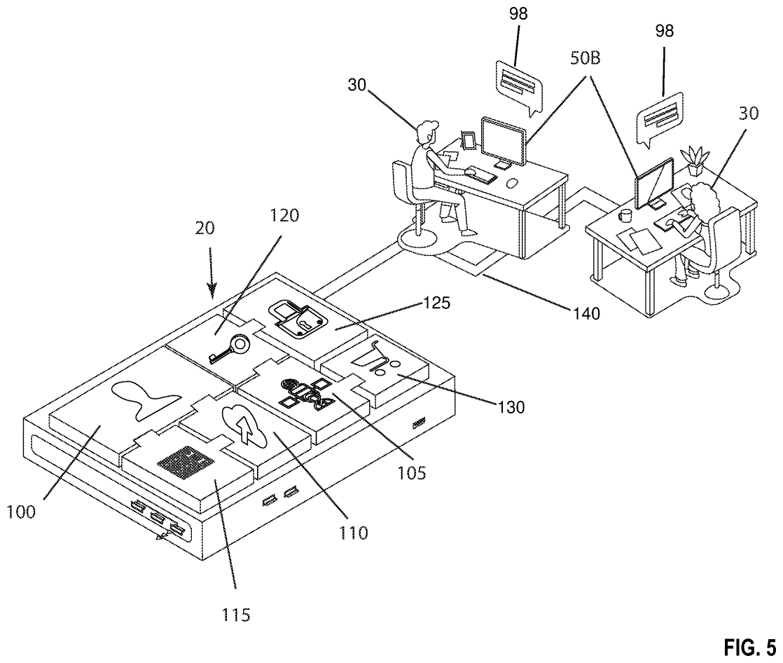

The software application (40) may also be configured to provider users (30) with the ability to control advertisements (70) displayed to them whilst engaged in online activity. In this regard, Segment 400 of FIG. 1 shows example interfaces including a first interface (180) in which users may indicate which categories of advertising they prefer to be shown, and a further interface (190) which may be utilized by the user (30) to engage in online activity including to navigate through social media streams, search engines, and the like (95), with the assurance that any advertisements (70) displayed will have undergone a rigorous assessment or are appropriately marked (90) to indicate possible risks associated with accessing same, as further detailed in FIG. 4. Segment 500 of FIG. 1 shows additional users (30) utilizing their fixed location computer devices (50B) to engage in similar online activity with the assurance that any advertisements presented are legitimate or at least marked (90) with a notification/warning, as further detailed in FIG. 5.

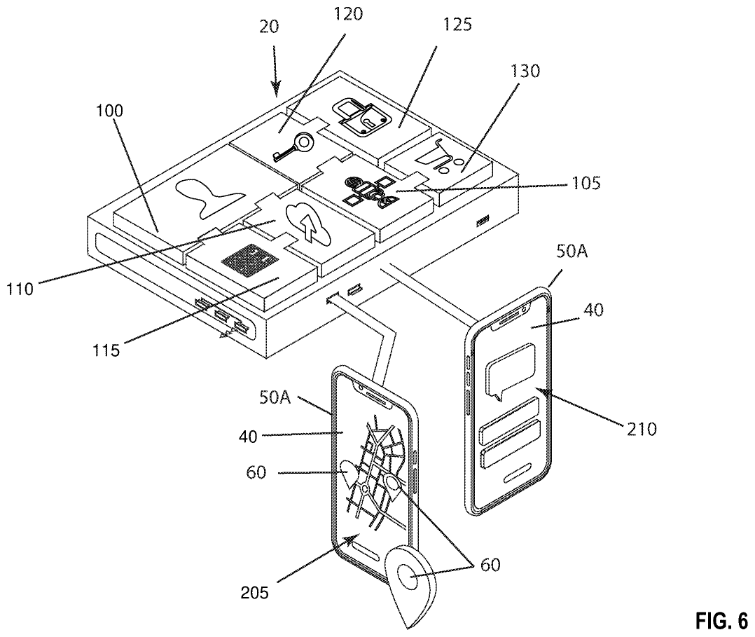

Segment 600 of FIG. 1 shows additional example interfaces including a location interface (205) that enables users (30) to enter location details and/or allow their location (60) to be monitored for the purpose of enabling all users within a geographical vicinity to be notified regarding false and/or deceptive advertisements encountered by the user (30), and a further interface (210) enabling a chat facility amongst registered users as well as with one or more administrators of the platform, as further detailed in FIG. 6.

As mentioned above, FIG, 2 shows in greater detail segment 200 of FIG. 1 and in particular, FIG. 2 shows the server component (20) which includes infrastructure upon which the platform of the present disclosure operates. The infrastructure may be local or cloud-based. The central server (20) may operate one or more computer processors and maintain one or more databases to enable the following functionality and/or storage:
User account register (100) storing details of each user (30) (e.g. name, address, contact details and any additional detail which may be relevant for the purpose of identifying each user). Details relating to identified entities responsible for posting advertisements (also referred to herein as advertising entities) may also be stored in the user account register or any associated database so as to maintain a record of such advertising entities;
Social media account register (105) storing details relating to social media user accounts associated with each user (30), which may include links and additional information that identify and associate particular social media accounts with individual users (30). Register (105) may also store information relating to other websites upon which users (30) engage in online activity and where advertisements are likely to be presented to users, such as software apps for online shopping, etc.;
Advertising entity profile databases (110) storing details relating to entities recorded as responsible for posting particular advertisements (70), including advertisements which have been assessed as legitimate as well as advertisements which have been flagged or assessed as including false and/or deceptive content (80). Database (110) may also include details relating to the results of verification with respect to such entities using verification functionality (120);
Location database (115) storing details relating to locations (60) of each user (30) (e.g. physical address, current location, and/or preferred location), where a current location may be detected using Global Positioning System (GPS) functionality of data communication devices (50) associated with users (30). Database (115) may also store a record regarding historical movements of each user (30), in circumstances where the tracking of such data is permitted by the user (30). The storage of location data in this way may improve the platform's ability to assess advertisements regarding false and/or deceptive content and determine whether particular geographical locations or regions are being targeted by particular advertising scams, as described in greater detail below;
Verification functionality (120) for verifying advertising entities including those stored in the database (110), including for example by comparing the entity name with data stored in a local or external database of known approved and/or known fraudulent advertiser profiles;
Data processing functionality (125) for processing content (95) from social media and other accounts associated with users (30) to identify advertisements (70) and to determine the presence of false and/or deceptive content (80) based upon the presence of publications of the advertisement for the same goods/services by other entities, and the presence of publications of the advertisements for the goods/services at a price other than as advertised in the advertisement under assessment. As described in greater detail below, the data processing functionality (125) may utilize one or more machine learning models which may be trained over time to more accurately identify advertisers whose advertisements should either be blocked or indicated as likely to include false or deceptive content;
Payment gateway (130) for processing any financial transactions that may be required through the platform including when the platform is utilized for retail purposes (e.g. where advertisements identified as legitimate are presented directly to the user (30) using the software application (40)), the payment gateway enabling users (30) to purchase goods or services associated with the advertisements utilizing payment gateway functionality (130), as well as for processing any other financial transactions such as subscription fees or the like.

FIG. 2 also depicts server (20) configured to enable communication (140) with the devices (50) and, in particular, the software application (40) operating on each device (50). Such communications may occur across the internet or other data communications network.

FIG. 3 shows in greater detail segment (300) of FIG. 1 and, in particular, the steps associated with a user (30) installing (150) the software application (40) on their device (50A), and subsequently accessing a user login and registration interface (160) associated with the application (40). Such access may be granted after the user (30) has installed the application (40) which may be achieved by downloading the application (40) from an application store. Each user (30) may create an account (which may include a user profile) using the application (40) and the account/profile information may be stored in the user account register (100).

The interface (160) may also be utilized by users (30) to input details relating to their social media accounts or any other account, website, etc., which the user typically accesses when engaging in online activity including, in particular, online shopping. Once sufficient data has been received from a particular user (30), the processing functionality (125) of the server 20 may commence the processing of content from the social media or other linked accounts/websites associated with the user (30) in order filter the streams of data (95) to identify content regarding advertisements (70). Given that advertisements (70) may appear at any time when users (30) are engaged in online activity, the data processing (125) may occur on a continuous basis or at regular intervals in order to ensure that newly posted advertisements (70) are captured and assessed for validity in substantially real-time. However, when users (30) are clearly offline and not engaged in such activity, then the platform may be configured to recognize same and conserve resources by not conducting the otherwise required monitoring/assessment described above, until such time that the user (30) returns online.

As part of processing the content, additional information associated with each identified advertisement (70) may be retrieved including details relating to the advertising entity responsible for posting the advertisement (70). In this regard, advertising profiles may be established in respect of such entities and stored in database (110). Furthermore, such entities may be subjected to a verification process including by comparing the entity details with data stored in one or more local or external databases of known advertising entities (e.g. retailers, suppliers, manufactures, etc.), including databases of registered and legitimate advertising entities managed by third parties. For example, the server (20) may be configured to interface with such databases using an application programming interface (API) or similar.

Interface (170) shown in FIG. 3 represents this capability of the software application (40) to verify advertiser entities, although it is to be understood that such verification may occur in the background without the user (30) necessarily notified that such verification is taking place. Entities which are verified as legitimate advertisers of goods may be categorized accordingly in database (110), and external databases may also be updated accordingly. Subsequently, advertisements posted by such entities may automatically pass through the assessment process and avoid being withheld from publication during the user's online engagement. Likewise, any advertising entities that have a history of posting false and/or deceptive advertisements may have their advertisements automatically withheld, or receive greater scrutiny in respect of their advertisements (e.g. a higher threshold) during subsequent assessments.

FIG. 4 shows in greater detail segment 400 of FIG. 1 and, in particular, a first example interface (180) which enables users (30) to provide additional preferences with respect to advertisements (70) which they prefer to view during their online engagement. For example, a user (30) may have particular interest in clothing and may enter a preference to only be presented with advertisements (70) relating to clothing to the exclusion of all other advertisements. Alternatively, users (30) may select to receive predominantly advertisements relating to clothing with other related advertisements also allowed to be published. In this regard, there are multiple categories of goods and/or services which may be the subject of advertisements, and the user (30), through utilization of the software application (40), may control the category of advertisements displayed to them. The category of each advertisement (70) may be identified during the previously described processing of content associated with each advertisement under assessment, including through the utilization of artificial intelligence techniques such as natural language processing.

The second interface (190) shown in FIG. 4 enables the user (30) to engage in online activity including accessing their social media sites, and to receive advertisements (70) during such activity. By assessing advertisements prior to their publication, and withholding (or appropriately flagging) advertisements (70) which are considered to include deceptive content (80), it will be appreciated that the user (30) is assisted with respect to advertisement selection in a manner that will reduce instances of users (30) being subjected to fraudulent activity. In the event that an advertisement (70) is identified as sufficiently likely to include deceptive content (according to a pre-defined threshold), the advertising content may be withheld and any additional advertising content from the particular advertising entity may also be withheld. In an alternative non-limiting embodiment, such advertisements (70) may be presented to the user but with a graphical indication (90) which may include a percentage likelihood of the advertisement being false or deceptive, or an indication that the advertisement falls within a particular category with respect to the likelihood that the advertisement includes false or deceptive content (80). For example, the likelihood categories may include “unlikely”, “likely”, or “extremely likely”. A description or summary of the deceptive content (80) may also be presented to the user (30) through interface (190), and based on a review of same, the user (30) may elect to disregard the warning and access the content regardless.

FIG. 5 shows in greater detail segment 500 of FIG. 1 and, in particular, an alternative non-limiting embodiment in which additional users (30) utilizing their fixed location computers (50B) to engage in online activity, and through the use of software application (40) control the quantity and/or quality of advertisements being presented during their online engagement. FIG. 5 also shows how users (30) may report (98) their encounters with false or deceptive advertisements which may not have previously been detected by the platform. Since the data processing functionality (125) is responsible for processing advertisement content and determining the presence of deceptive content, the functionality (125) may involve the use of a machine learning model that utilizes such feedback from users (30) in order to learn where previous assessments were inaccurate and to address the assessment to ensure that similar inaccurate assessments are not repeated.

Further, such feedback (98) may be utilized to learn the characteristics of entities (e.g. advertisers) who are likely to include false or deceptive content in their advertisements, wherein the machine learning model may be trained over time to better determine those advertisers who should either be blocked or alternatively be indicated as advertisers likely to post false and/or deceptive advertisements. In other words, once the machine learning model is sufficiently trained, input into the model may include data from the received social media streams (95) associated with one or more users (30), and the output of the machine learning model may be in the form of recommendations or predictions regarding the likelihood of particular advertisements (70) identified in the data streams (95) including false and/or deceptive content (80).

In addition to being trained based upon feedback (98) from users (30), the machine learning model may also be trained based upon feedback by retailers and/or suppliers who have advertised goods and/or services but whose advertisements (70) may have been incorrectly withheld on the basis that they included false or deceptive content (80). In this regard, the software application may also be utilized by such entities with the ability for such entities to be notified regarding the withholding or flagging (95) of any of their advertisements (70), and thereby providing such entities with the ability to provide feedback including in relation to the legitimacy of their advertisements.

FIG. 6 shows in greater detail segment 600 of FIG. 1 and, in particular, additional example interfaces (205) and (210). Interface (205) enables users (30) to enter information relating to a location (60) associated with the user (30) (e.g. a location representing their physical address, or a current or preferred location). Alternatively, location data associated with each user (30) may be automatically tracked utilizing the global positioning system (GPS) tracking capability associated with each user device (50), assuming the user (30) provides relevant authorization in respect of same.

The advantage associated with recording and tracking the location of users (30), in addition to tracking the reporting of false or deceptive advertisements by each user (30), is that any geographic regions or locations that are targeted by a particular advertising entity may be more easily recognized and addressed. In one example, the system may be configured to monitor advertisers considered likely to include deceptive content (80) in their advertisements (70) according to the geographic region in which online users (30) reside (or are located) and to whom advertisements (70) are provided, wherein upon detection of advertising including false or deceptive content (80), the particular advertising entities advertising to all online users (30) located in the relevant geographic region may be appropriately withheld. By monitoring and recording such information, it will also be appreciated that an administrator of the platform or any other relevant entity may utilize such data for analytical purposes including establishing which locations or geographical regions are being targeted, and the extent to which different locations or geographic regions have been targeted as compared with other locations or regions.

The interface (210) shown in FIG. 6 also provides a chat facility which may be utilized by registered users (30) in order to communicate with respect to particular goods or services of interest including in relation to advertisements (70) relating to same. Registered users (30) may also utilize the chat facility to place other users within a community of users on notice regarding false or deceptive advertisements which they have encountered. In this regard, the chat facility may also be utilized by users (30) to communicate such alerts to a platform administrator. Interface (210) may also be utilized for the purpose of providing users (30) with relevant alerts and/or notifications including in relation to advertisements (70) to avoid, based upon the most recent assessments conducted by the platform. For example, it may be that a particular advertisement (70) is allowed to be published but subsequently assessed (based on user feedback) as likely to include false or deceptive content (80), in which case the advertisement (70) may already have attracted engagement with one or more registered users (30). In these circumstances, the interface (210) may provide useful alerts and/or notifications to other users (30), including to cease further engagement with the particular advertisement (70).

Whilst not shown, the computer software application (40) may present yet a further interface in which the payment gateway functionality (130) of the server is accessible by users (30) including to make subscription payments for the continued utilization of the software application (40), or for any other reason that may require financial transactions to be processed through the application (e.g. through online shopping conducted through the application (40), etc.).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various non-limiting embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of non-limiting embodiments herein illustrate one or more control or processing units. It is to be understood that the processing or control units may represent circuits, circuitry, or portions thereof that may be implemented as hardware with associated instructions (e.g. software stored on a tangible and non-transitory computer readable storage medium, such as a computer hard drive, ROM, RAM, or the like) that perform the operations described herein. The hardware may include state machine circuitry hardwired to perform the functions described herein. Additionally, or alternatively, the hardware may include electronic circuits that include and/or are connected to one or more logic-based devices, such as microprocessors, processors, controllers, or the like.

Additionally or alternatively, the one or more processors may represent processing circuitry such as one or more of a field programmable gate array (FPGA), application specific integrated circuit (ASIC), microprocessor(s), and/or the like. The circuits in various non-limiting embodiments may be configured to execute one or more algorithms to perform functions described herein. The one or more algorithms may include aspects of the non-limiting embodiments disclosed herein, whether or not expressly identified in the figures or a described method.

It will be appreciated by persons skilled in the relevant field of technology that numerous variations and/or modifications may be made to the non-limiting embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for reducing individuals from exposure to false and/or deceptive online advertising, the method comprising:
receiving, by one or more processors, social media streams from social media sites for one or more social media user accounts associated with a user and filtering the social media stream(s) to identify content regarding advertisements for goods and/or services;
processing, by one or more processors, the content by subjecting each advertisement identified in the stream(s) to an assessment process to identify any false and/or deceptive content, wherein the assessment process comprises:
determining whether the advertisement has been published anywhere in the world by an entity other than the advertising entity associated with the advertisement under assessment,
determining whether the goods and/or services have been advertised anywhere in the world for a price other than as advertised in the advertisement being under assessment,
determining a likelihood that the advertisement under assessment includes false and/or deceptive content according to either one or both of:
the presence of one or more publications of the advertisement for the goods and/or services by an entity other than the advertising entity associated with the advertisement under assessment, and
the presence of one or more publications of the advertisement for the goods and/or services at a price other than as advertised in the advertisement under assessment; and
based on a determination that the advertisement includes false and/or deceptive content above a pre-determined threshold:
withholding, by one more processors, provision of the advertisement to the user, or
providing, by one or more processors, the advertisement to the user with a warning that the advertisement is likely to be false and/or deceptive.

2. A method according to claim 1, wherein determining the presence of one or more publications of the advertisement for the goods and/or services by any entity other than the advertising entity associated with the advertisement under assessment, or determining the presence of one or more publications of the advertisement for goods and/or services at a price other than as advertised in the advertisement under assessment, comprises automatically conducting a search for other online advertisements that pertain to goods and/or services that are identical to those advertised in the advertisement.

3. A method according to claim 2, wherein searching for other online advertisements that pertain to goods and/or services identical to those advertised in the advertisement comprises one or more of:
searching using an online search engine, or
searching a database or repository of active online advertisements.

4. A method according to claim 1, wherein the warning provided to the user when an advertisement is considered likely to be false and/or deceptive, comprises one or more of:
information pertaining to the false and/or deceptive content;
a graphical display alerting the user to the false and/or deceptive advertisement;
a percentage indication of likelihood that the advertisement includes false and/or deceptive content, or
an indication regarding a category of likelihood that the advertisement includes false and/or deceptive content is applicable, the category being one of a plurality of different likelihood categories.

5. A method according to claim 4, wherein the plurality of different categories of likelihood that the advertisement includes false and/or deceptive content include:
likely,
unlikely, and
extremely likely.

6. A method according to claim 1, further comprising:
determining, by one or more processors, particular entities as legitimate advertisers of goods and/or services based upon a threshold number of advertisements issued by the entities determined not to include false and/or deceptive content, and
automatically allowing advertisements from entities determined to be legitimate advertisers of goods and/or services to be provided to users.

7. A method according to claim 6, further comprises:
determining, by one or more processors, particular entities as illegitimate advertisers of goods and/or services based upon a threshold number of advertisements issued by the entities determined to include false and/or deceptive content,
storing, in a repository, details relating to the entities determined to be illegitimate advertisers of goods and/or services, and
automatically withholding advertisements from users with respect to advertisements from entities determined to be illegitimate advertisers of goods and/or services.

8. A method according to claim 7, further comprising:
training, by one or more processors, a machine learning model with respect to the characteristics of entities determined to be illegitimate advertisers of goods and/or services, and
utilizing, by one or more processors, the trained machine learning model to assess new entities regarding their legitimacy including whether the advertisements provided by the entities include false and/or deceptive content according to the pre-determined threshold.

9. A method according to claim 8, wherein the characteristics of entities used to train the machine learning model are determined based upon one or more of:
accessing a database storing details relating to the entities,
feedback from users in relation to their encounters with entities who have provided false and/or deceptive advertisements, and
feedback from entities who have been erroneously determined as illegitimate advertisers of goods and/or services.

10. A method according to claim 7, wherein when one or more publications of the advertisement for the goods and/or services by a particular entity other than the advertising entity associated with the advertisement under assessment is located, the method further comprises:
determining, by one or more processors, whether the particular entity is recorded in the repository of entities determined to be illegitimate advertisers of goods and/or services, and
based upon the entity not being recorded in the repository and hence likely to be a legitimate advertiser of goods and/or services, determining, by one or more processors, that the advertisement includes false and/or deceptive conduct according to the pre-determined threshold.

11. A method according to claim 1, wherein when one or more publications of the advertisement for the goods and/or services at a particular price other than as advertised in the advertisement under assessment is located, the method further comprises:
determining, by one or more processors, the extent to which the particular price differs from the price advertised in the advertisement, and
based upon the particular price exceeding the price advertised in the advertisement by more than a predefined percentage of the advertised price, determining, by one or more processors, that the advertisement includes false and/or deceptive conduct above the pre-determined threshold.

12. A method according to claim 1, wherein only those advertisements associated with a particular category or categories selected as of interest to the user are provided to the user to the exclusion of advertisements associated with other categories.

13. A method according to claim 1, further comprising:
determining, by one or more processors, the advertising entity associated with the advertisement under assessment, and
verifying, by one or more processors using one or more verification techniques, the advertising entity as a legitimate advertiser of goods and/or services.

14. A method according to claim 1, further comprising:
prompting, by one or more processors, the user to specify a geographical location associated with the user, or
automatically tracking, by one or more processors, a geographical location of the user using the global positioning system functionality implemented by a user's device.

15. A method according to claim 14, further comprising:
storing, by one or more processors, details relating to advertisements considered to contain false and/or deceptive content and associating same with the geographical location of users who have received the advertisement, and
determining, by one or more processors, any geographical regions targeted by an advertising entity responsible for issuing the advertisement.

16. A method according to claim 14, further comprising:
based upon detection of a user in a particular geographic location receiving an advertisement that contains false and/or deceptive content, automatically withholding further advertisements from the advertising entity responsible for issuing the advertisement, and alerting other users within a predefined vicinity of the geographic location of the user to be aware that such advertisements have been received by another user within the same geographical region.

17. A method according to claim 1, further comprising:
providing, by one or more processors, a chat facility enabling users to communicate with one another regarding false and/or deceptive advertisements encountered by users.

18. A computer-implemented system for reducing individuals from exposure to false and/or deceptive online advertising, the system comprising:
one or more processors configured to:
receive social media streams from social media sites for one or more social media user accounts associated with a user and filtering the social media stream(s) to identify content regarding advertisements for goods and/or services;
process the content by subjecting each advertisement identified in the stream(s) to an assessment process to identify any false and/or deceptive content, wherein the assessment process comprises:
determining whether the advertisement has been published anywhere in the world by an entity other than the advertising entity associated with the advertisement under assessment,
determining whether the goods and/or services have been advertised anywhere in the world for a price other than as advertised in the advertisement under assessment, and
determining a likelihood that the advertisement under assessment includes false and/or deceptive content according to either one or both of:
the presence of one or more publications of the advertisement for the goods and/or services by an entity other than the advertising entity associated with the advertisement under assessment, and
the presence of one or more publications of the advertisement for the goods and/or services at a price other than as advertised in the advertisement under assessment; and
based on a determination that the advertisement includes false and/or deceptive content above a pre-determined threshold:
withhold provision of the advertisement to the user, or
provide the advertisement to the user with a warning that the advertisement is likely to be false and/or deceptive.

19. A computer-readable medium comprising computer instruction code that, when executed on a computer, causes one or more processors of the computer to perform the steps of:
receive social media streams from social media sites for one or more social media user accounts associated with a user and filtering the social media stream(s) to identify content regarding advertisements for goods and/or services;
process the content by subjecting each advertisement identified in the stream(s) to an assessment process to identify any false and/or deceptive content, wherein the assessment process comprises:
determining whether the advertisement has been published anywhere in the world by an entity other than the advertising entity associated with the advertisement under assessment,
determining whether the goods and/or services have been advertised anywhere in the world for a price other than as advertised in the advertisement under assessment, and determining a likelihood that the advertisement under assessment includes false and/or deceptive content according to either one or both of:
the presence of one or more publications of the advertisement for the goods and/or services by an entity other than the advertising entity associated with the advertisement under assessment, and
the presence of one or more publications of the advertisement for the goods and/or services at a price other than as advertised in the advertisement under assessment; and
based on a determination that the advertisement includes false and/or deceptive content above a pre-determined threshold:
withhold provision of the advertisement to the user, or
provide the advertisement to the user with a warning that the advertisement is likely to be false and/or deceptive.

20. (canceled)
